(19) United States
(12) Patent Application Publication
(10) Pub. No.: US 2003/0144853 A1
(43) Pub. Date: Jul. 31, 2003

(54) Carton labeling system and process

(76) Inventors: William J. Stehouwer, Grand Ledge, MI (US); Reha Emden, Okemos, MI (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 10/057,265

(22) Filed: Jan. 25, 2002

(51) Int. Cl. G06F 17/60

(52) U.S. Cl. 705/1

(57) ABSTRACT

A customer interface with a printing facility allows communication between the printing facility and customer for receiving customer order information including graphic and printing information for labeling relatively heavyweight cartons. The facility prints labels conforming to the shape of the cartons and cuts and laminates the labels onto individual cartons. A graphics computer with a microprocessor converts customer information into label size and graphics information; a digital press prints web stock with a plurality of labels; a finishing machine die cuts, singulates and stacks the labels; and a laminating press applies the labels in indexed relationship to cartons. The customer interface can be through the internet to fill “just in time” customer needs.

### BACKGROUND OF THE INVENTION

The present invention relates to a method and apparatus for applying labels to cartons for displaying the contents of the cartons.

With today's increasing efforts to efficiently provide customers with products, “just in time” techniques for supplying commercial customers with products which are subsequently integrated into completed products is becoming increasingly challenging. In the printing industry, packaging must be supplied to customers in a coordinated manner such that the product being packaged can be correctly identified, matched with the package, and subsequently the packaging of the product completed.

For long run mass production of cartons, for example, used for packaging consumer products, typically analog offset presses are employed to print directly onto the cartons. Although useful for such purposes, such printing methods require a significant set-up time and are not cost effective for smaller volume printing nor does such printing method allow for rapids changing of information in response to customer printing needs.

In order to provide custom “just in time” service, it is often desirable to employ customer provided artwork for the packaging and use digital processing techniques for the graphics and other printed material contained on the package and employing digitally controlled printing presses for the printing of such packages. This allows, for example, on-line internet interface between the customer and the printer to provide order information and completion of the printing process.

Existing digital printing presses, however, cannot accommodate the thicker fiberboard products required with many packages with the current state of the art allowing printing on packages of only up to 14-point board. There exists a significant demand for packages from the 18-point to 22-point board thickness and particularly the higher end 22-point board thickness, for a variety of items including, for example, medical instruments which must be carefully handled and which must undergo sterilization techniques once packaged. Such relatively high end products require heavier duty packaging, the surfaces of which cannot be printed utilizing high speed digital printing systems currently available. Thus, there exists a need for an apparatus and system which will allow the printing supplier to respond to customer orders quickly and provide relatively small volume runs of heavy duty packaging which is appropriately labeled using the speed and desirable interface ability of digital printing techniques and equipment.

### SUMMARY OF THE INVENTION

The system and method of the present invention satisfies this need by providing a customer interface with the printing facility which allows communication between the printing facility and customer for receiving customer order information, graphic and printing information which is converted to digital data which can be supplied to a digital press. The customer information provides carton number, size, shape, and graphic printing information to the printing facility which, utilizing a digital printing apparatus, prints labels conforming substantially to the surface of a carton. The method and apparatus subsequently laminates the preprinted, die cut labels onto cartons. This allows the printing facility to rapidly respond to customer orders in a “just in time” on demand manner to supply the customer with desired preprinted cartons. The method and apparatus provides relatively high speed production for relatively small volume custom printing jobs.

The apparatus embodying the present invention includes a customer interface such as through an internet connection or other digital data format providing dimensions, graphics and printed information for a label; a graphics computer with a microprocessor for converting such customer information into label size and graphics information; a digital press for receiving web stock material for printing and printing a plurality of labels on the web stock; a finishing machine for die cutting, singulating and stacking individual labels; and a laminating machine for applying labels to cartons. The printing capabilities of such a system allows relatively heavyweight cartons to be efficiently labeled in a manner which simulates direct carton printing.

These and other features, objects and advantages of the present invention will become apparent upon reading the following description thereof together with reference to the accompanying drawings.

### BRIEF DESCRIPTION OF THE DRAWINGS

FIG. 1 is a perspective exploded view of a carton and matching label to be applied to the carton;

FIG. 2 is a flow diagram of the method of receiving and completing customer carton printing orders by a printing facility;

FIG. 3 is a schematic diagram of a digital printing press for printing labels, such as the label of FIG. 1;

FIG. 4 is a side schematic view of a finishing machine for receiving rolls of printed labels, die cutting, singulating, and stacking them for subsequent processing;

FIG. 5 is a side schematic view of a laminating machine for receiving cartons and stacks of preprinted labels applying an adhesive to one of the labels and carton, aligning the label and carton, and pressing the carton to the label for laminating the two and subsequently discharging them to an output station; and

FIG. 6 is an enlarged cross-sectional view of a carton and label as oriented during the lamination step.

### DETAILED DESCRIPTION OF THE PREFERRED EMBODIMENT

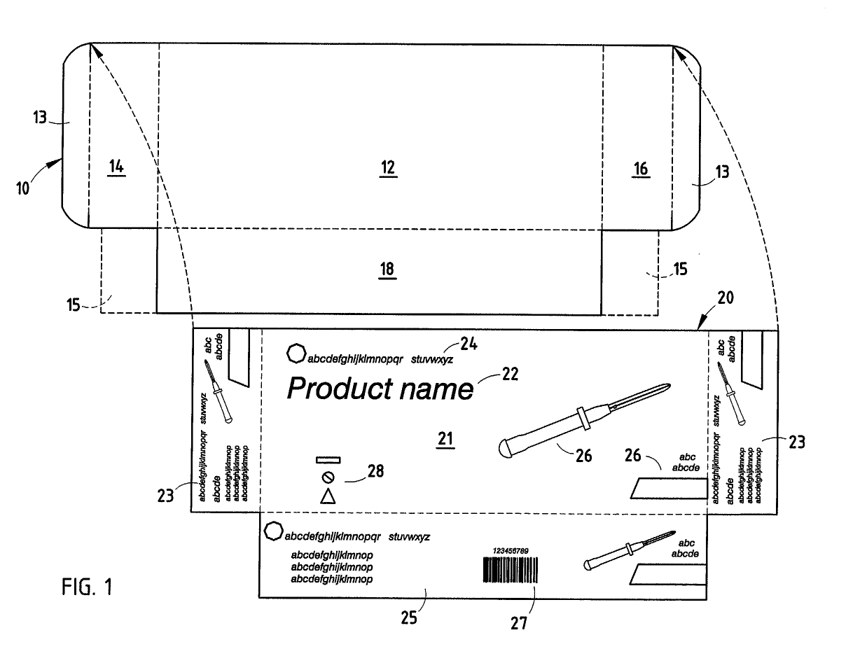

Referring initially to FIG. 1, there is shown a carton 10 which is to be labeled with graphic and printed information identifying products contained in the carton, supplier of the product, and any printed label information necessary, required, or desirable. The carton is available from any number of commercial carton manufacturers and, for purposes of the present invention, is of a relatively thick material which cannot be directly printed upon utilizing high speed digital presses. Thus, carton 10 may have a thickness of from about 18-point to 22-point fiberboard material, although it can be of greater or lesser thickness. The carton is preglued and folded, as seen in FIG. 1, to present a principal display panel 12, left and right end panels 14 and 16, and a side panel 18, all of which are substantially covered by an overlying conforming label 20.

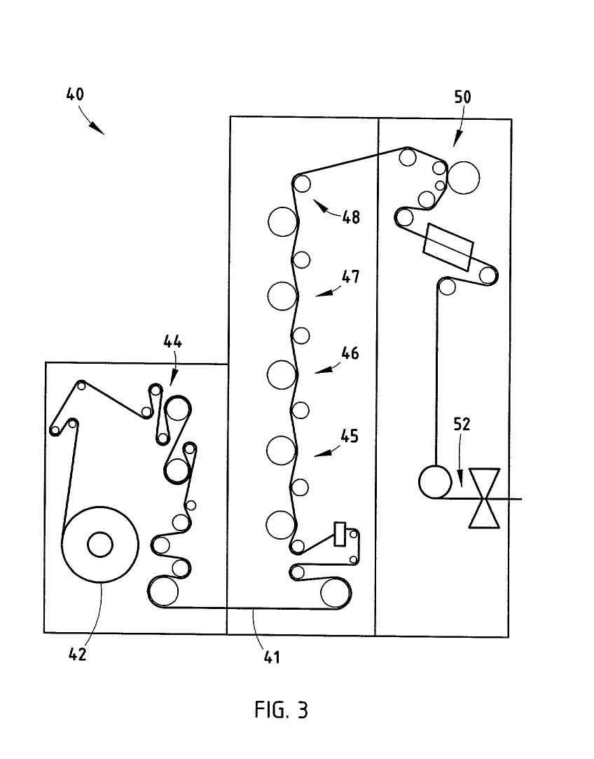

Label 20 is shaped to substantially overly and be congruent with carton surfaces 12, 14, 16, and 18, it being noted that carton 10 includes end flaps 13, which are not labeled, and corner flaps 15 (shown in dotted lines) also which may be folded under side panel 18 during the lamination process or exposed as desired. Label 20 includes several printed areas, including a principal display surface 21 which includes an area 22 for the product identification, area 24 for the supplier logo or trademarks of the manufacturer of the product, area 26 for the graphic representation of a product, such as a medical instrument as depicted in FIG. 1, and an area 28 for cautionary symbols or printed warnings. Label 20 also includes end flaps 23 which are aligned and overlie end panels 14 and 16 of carton 10 and which also include similar graphic, supplier, and product identification information as does the principal display surface 21. The side panel 25 of label 20 similarly includes areas for the product name, supplier identification, graphics identifying the product(s), and the UPC barcode 27. Label 20 can be any desired paper, such as 80 pound paper CIS which is commercially available in large continuous rolls of web stock and which can be handled by a digital printing press such as shown in FIG. 3 and a finishing machine as shown FIG. 4. Although the preferred paper is 80 pound C1S paper, other weight paper, film material, or other printable stock material having different finishes can be employed as required for individual printing needs.

Although the carton and label shown in FIG. 1 illustrate the labeling of only the principal display panel, end panels and one side panel, the method and apparatus of the present invention can be employed to generate a second label having the shape of the back panel, which would be the same shape as panel 12, and another side panel, which would be the same shape as panel 18. The second label would be printed and applied utilizing a repeat process and utilizing the same equipment and methods as described in connection with the first label 20.

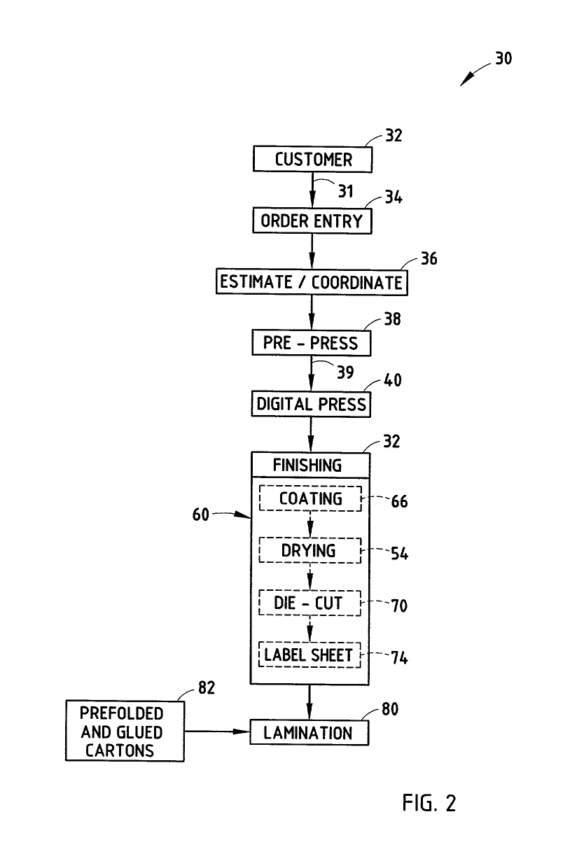

Referring now to FIG. 2, a flow diagram 30 represents the method of producing labeled cartons according to the present invention to allow a printing facility to provide a rapid turnaround and an automated response to customer orders. In FIG. 2, customer input is represented by block 32 and may include an internet connection such as 31 to an order entry computer represented by block 34 at the printer's facility. The customer entry can also be via mail or facsimile or by recorded digital media, such as magnetic disks, laser disks or the like, which contain order information and customer graphics to be employed in printing labels to be applied to cartons. The order information will, in addition to containing the graphics, customer information and the like, contain the volume of cartons and labels to be laminated, dates for delivery, costing information and the like. The costing information and coordination of the printing process is represented by block 36 at the printing facility and may include a computer with a microprocessor coupled to a computer database contained in the order entry block 34. The printing facility database will typically include customer identification information including shipping addresses, contacts, billing directions, standing printing orders and the like, all of which are employed to correlate with incoming individual order information from a customer to either print new orders or run a printing run against a standing order until the order is filled and can be controlled by, for example, a software program such as DOC Express® available from Impressive Solutions. Thus, the software for controlling inventory flow and a customer database employed by the printing facility may employ such software to coordinate order entries as well as the pre-press data entry as represented by block 38.

Block 38 typically will include a graphics computer, such as an Apple® computer, which will have graphics programs, such as Adobe®, Apple Script®, Post Script® software or the like, as well as DOC Express® to allow the operator to verify the customer information and lay out label graphics printing material on the proper label size for an individual carton to be labeled. Blocks 34, 36, and 38 can be coordinated with one computer with a microprocessor of sufficient capacity to handle graphics and operate the DOC Express® and the graphics software to provide at an output 39 digital information in the form of a magnetic disk, a laser CD or a direct serial or parallel data connection to a digital printing press 40 for printing on a continuous roll of web stock paper or other material a plurality of labels 20 to be applied to cartons 10.

The digital printing press 40 is illustrated in FIG. 3 in schematic form and includes an input roll 42 of paper, such as the 80 pound C1S paper noted above, and is located in an environment which is carefully controlled to ensure color accuracy. Thus, the press typically will be in a press room held at a room temperature of, for example, 74° F. controlled within plus or minus one degree at fifty-percent humidity plus or minus two percent on an anti-static floor with a neutral gray wall color and color balanced lights to allow operators, not only in steps 34-38 but also throughout the printing and subsequent manufacturing process, to monitor the color and accuracy of labels being applied to the cartons. Press 40 may be a commercially available press, such as the Xeikon® DCP 320 S system or an Indigo® press which pretreats the papers in station 44 for subsequent multi-colored printing in subsequent charging and printing individual color stations 45, 46, 47, and 48 followed by a subsequent drying and fixing station 50.

The digital data format can be in postscript format, PDF file format, or TIFF files, and typically the press will include its own computer including a microprocessor operating under a Windows® platform, such as the currently available Windows® 2000, for receiving the information from pre-press block 38 for the continuous roll printing of labels. The press includes an output station 52 which supplies a continuous web of now pre-printed paper stock from roll 42 onto an accumulating roller (not shown in FIG. 3 but shown as element 54 in FIG. 4), which once the label printing run is completed, is moved to the finishing machine 60 of FIG. 4.

Printer 40 has a 600 dot per inch resolution capability and employs an LED array based dry toner electro-photography process utilizing in stations 45, 46 and 47 white, yellow, cyan, magenta followed by black in station 48. It can operate at a web speed of up to 48 feet per minute for printing rows of labels 20 on a continuous web 41 of print stock which is subsequently processed as now described in connection with FIG. 4. The printer, for example, can print at a rate of 22 labels per minute for custom labels having a length of 26 inches.

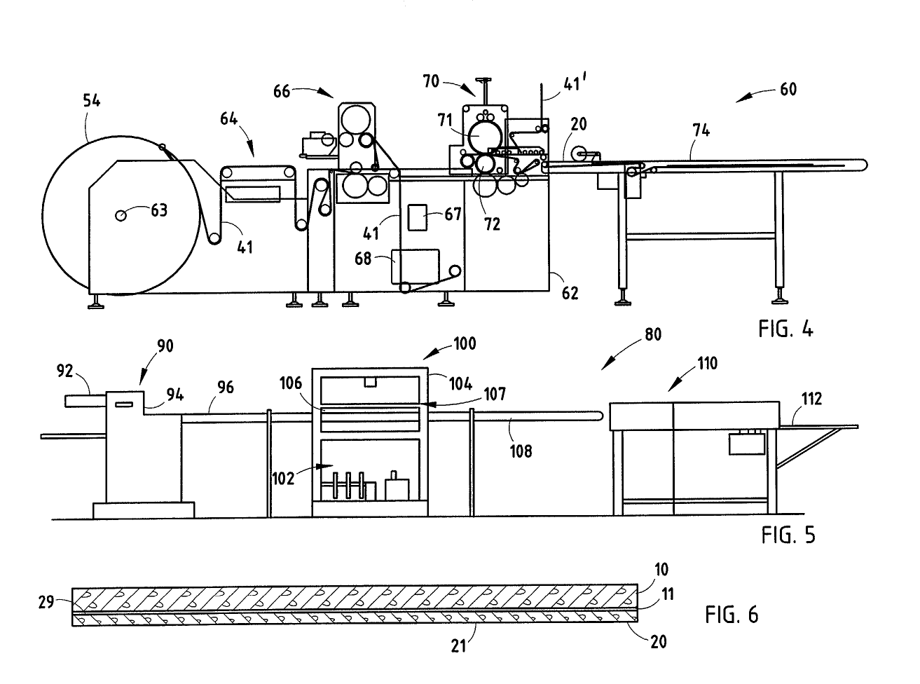

The finishing process and station is represented by block 60 in FIG. 2. The machine is shown in schematic form in FIG. 4. This process includes feeding the roll of preprinted web stock 54, coating the printed surface, drying the coated surface, die cutting individual labels 20 from the web stock, singulating and stacking the individual die cut labels. Turning to FIG. 4, the machine for accomplishing these finishing processes is mounted to a framework 62 supporting an axle 63 for holding the roll 54 of printed web stock and feeding the web 41 therefrom through a web guide splice table 64 which controls the feeding of the web stock into a flexographic print unit 66 which applies varnish from a sliding cartridge to the printed surface of each of the labels 20 for protecting the label from abrasion during handling. After a coat of varnish is applied to the labels, the web 41 passes downwardly through a heater 67 and into an air cooled UV curing unit 68 and subsequently to a precision rotary metal-to-metal die cutting station 70. Station 70 die cuts the individual labels from the web stock 41. As noted earlier, the web stock may include rows of from about three to five labels aligned across the width of the web stock 55 and longitudinally aligned successive rows. The die cutting station 70 includes an upper rotary die 71 and a lower rotary die 72 synchronously driven for cutting the labels 20 from the web stock 41. The dies are machined from the digital label shape and size information to precisely cut labels from the web stock. The web stock waste 41′ is then exited from the machine while the labels 20 are singulated and stacked on a shingle conveyor 74 for subsequent application to the cartons in the laminating step 80 shown in block form in FIG. 2 and in schematic form in FIG. 5. Although a clear varnish is employed in the preferred embodiment of the invention, other protective coatings may also be applied prior to the die cutting and subsequent processing of the labels.

The laminating machine 80 shown in FIG. 5 receives prefolded and glued centers 10 shown by block 82 in FIG. 2. Machine 80 comprises three interrelated stations including a label singulator and gluing station 90; a carton handling and label registration and application station 100; and a smoothing roller and stacking station 110, it being understood that the flow of the process is from left to right in FIG. 5 as is the flow of label processing shown in machine 60 of FIG. 4. Machine 80 and its components include a laminating, flat board wrapper machine, which can be of the type commercially available from Emmeci USA LLC of Providence, R.I. and identified as a laminating line flat board wrapper Model No. MC2000. Station 90 receives the stacked precut patterned labels 20 (FIG. 1) from the output 74 of machine 60. Labels 20 are oriented in station 90 with the printed side facing downwardly and the back of the label facing upwardly. Station 90 includes a vacuum lifting mechanism 92 for handling individual labels from a stack of labels and introducing them into a glue viscosity control unit 94 which employs a hot melt glue which rolls glue onto the upper exposed surface of the label rear surfaces utilizing stainless steel rollers.

A vacuum holding perforated endless belt conveyor 96 transfers the individually sequentially fed labels into laminating station 100 which holds a plurality of stacked cartons 10 in an in-feed station 102. Station 100 includes a vacuum lift programmable transfer assembly 104 which picks up individual cartons with panels 12, 14, 16, and 18 facing downwardly and applies the cartons in registered relationship to the labels at interface 106. The alignment is controlled by suitable sensors and/or index marks which may be printed on the cartons and/or labels to assure alignment of the label to the carton to within 1/64″ such that the end product, when the label stock color is the same as the carton, appears to be a directly printed carton. A laminating section 107 includes a platen for applying pressure to the carton onto the upwardly facing glue of the label. Subsequently, the labeled cartons are fed by a conveyor 108 to a smoothing rotary press 110 which applies pressure to remove any trapped air between the label and cartons and which includes an output stacker 112 for stacking a plurality of the now labeled cartons for packaging and shipment to the customer. The finishing and laminating steps have a relatively high speed through part 16 at least about 40 finished cartons per minute. A finished, laminated and labeled carton is shown in FIG. 6 in which carton 10 includes a label 20 applied thereto having a printed side surface 21 facing downwardly and an adhesive interface 11 extending between the back surface 29 of label 20 and the surfaces of panels 12, 14, 16, and 18 of carton 10.

The sections of machine 80 may include an Emmeci MC1/R automatic gluing machine forming station 90, an Emmeci MC B automatic spotter as the laminating station 100, and an Emmeci 30″ Potevin type rotary press Model No. MC A smoothing and stacking station 110. The speed of the laminating process can be as high as 40 units per minute to allow the relatively rapid, laminating of the precut, preprinted labels 20 onto the prefolded and glued matching cartons 10. Thus, with the system of the present invention, cartons having a thickness greater than that which can be printed directly using a digital press can have preprinted labels applied and laminated thereto utilizing an adhesive to provide a finished carton having the appearance of a preprinted carton to contain desired graphics, manufacturing information, trademarks, user instructions and the like thereon in a cost effective method and system for providing such packaging. Further, the method of handling the customer information graphics and digitally controlling the printing, cutting and laminating of labels onto the carton results in a rapid set up time to provide “just in time” response to customer custom printing needs such that it is not necessary for the customer to inventory prelabeled cartons for an significant period of time.

It will become apparent to those skilled in the art that various modifications to the preferred embodiment of the invention as described herein can be made without departing from the spirit or scope of the invention as defined by the appended claims.

The invention claimed is:

1. A method of producing labeled cartons comprising the steps of:
receiving customer supplied information including product information to be printed on a label, such information including label graphics and printing;
converting the received customer information into a digital format for use by a digital printing press;
printing labels in a shape conforming to cartons onto which the labels are to be applied using a web of continuous print stock in a digital printing press;
die cutting individual labels from the printed web stock;
stacking the labels for subsequent processing;
supplying cartons to be labeled;
applying an adhesive to one of a side of each label opposite the printed side and a side of a carton to be labeled; and
laminating the label to the carton by pressing the label and corresponding carton in indexed relationship.

2. The method defined in claim 1 and further including coating the printed surface of the label with a protective coating.

3. The method defined in claim 2 wherein said coating step comprises varnishing the printed surface of said label.

4. The method defined in claim 3 further including the step of smoothing the label and carton for removing air bubbles between the label and carton subsequent to the laminating step.

5. The method defined in claim 4 and further including the step of stacking the labeled cartons for subsequent transfer to a customer.

6. The method defined in claim 1 wherein adhesive is applied to the label.

7. The method as defined in claim 6 wherein the laminating step includes placing the carton over the label and pressing the carton downwardly onto the label.

8. The method defined in claim 1 wherein the customer identification information further includes the customer name and address, the number of labeled cartons to be provided, and the delivery date for the labeled cartons.

9. The method as defined in claim 8 wherein the printing facility includes a database for storing customer information including order information, and upon receipt of an individual order, correlates individual order information against the stored customer order information for filling the individual order.

10. The method as defined in claim 1 wherein the receiving step includes receiving customer information through an internet connection.

11. An apparatus for printing labels and subsequently laminating labels to a carton wherein the labels have a precut size matching that of the carton to which they are applied comprising:
a computer including a microprocessor and a graphics program for laying out label sizes, shapes, and graphic information to be contained on the label and providing an output digital file corresponding to such information;
a digital printer for receiving said output file from said computer with a microprocessor and printing a plurality of labels identified by said output file on continuous web stock;
a cutting machine for receiving the web stock and cutting and stacking individual labels therefrom; and
a laminating machine for applying an adhesive to one side of each label opposite the printed side and carton and laminating the label onto a carton in indexed relationship to the carton.

12. The apparatus defined in claim 11 wherein the cartons are fiberboard cartons having a thickness greater than 18 points.

13. The apparatus defined in claim 11 wherein said adhesive is applied to the label.

14. The apparatus defined in claim 13 wherein said adhesive is a hot melt glue.

15. The apparatus defined in claim 14 wherein said cutting machine includes a coating apparatus for coating the printed side of each label with a protective layer.

16. The apparatus defined in claim 15 wherein said protective layer is a varnish.

17. A method of producing custom labeled cartons comprising the steps of:
receiving digital data representing customer information including label graphics and printing to be printed on a package label;
confirming that the received customer information is in a digital format suitable for use by a digital printing press and converting such received information to a suitable digital format when required;
digitally printing labels in a shape conforming to cartons onto which the labels are to be applied on a web of continuous print stock employing a digital printing press;
cutting and singulating individual labels from the printed web stock;
applying an adhesive to a side of each label opposite the printed side; and
laminating the label and carton by pressing the label and corresponding individual carton in indexed relationship to each other.

18. The method defined in claim 17 and including the additional step of smoothing the label and carton for removing air bubbles between the label and carton subsequent to the laminating step.

19. The method defined in claim 18 and further including coating the printed surface of the label with a protective coating.

20. The method defined in claim 19 wherein said coating step comprises varnishing the printed surface of said label.

21. The method defined in claim 20 and further including stacking the labeled cartons for subsequent transfer to a customer.

22. The method defined in claim 17 and further including comparing the information received from the customer with a database pertaining to customer information for controlling individual printing runs according to customer orders.

23. A labeled carton made by the process of claim 17.

24. An apparatus for forming, printing, and laminating labels having a predetermined size and shape corresponding to cartons comprising:
a computer including a microprocessor and a graphics program for laying out label sizes, shapes, and graphic information to be contained on the label and providing an output digital file corresponding to such information;
a digital printer for receiving said output file from said computer and printing a plurality of labels identified by said output file on continuous web stock at a rate of up to about 48 feet per minute;
a finishing machine for receiving the web stock, coating the printed side of the label, and cutting and singulating individual labels therefrom;
an adhesive application station for applying an adhesive to the carton facing side of each label;
a laminating station for aligning each label in indexed relationship to a carton and pressing the label and carton together to apply the label to the carton;
a smoothing station comprising a rotary press for removing air bubbles between a label and a carton; and
a stacking station for stacking labeled cartons.

25. The apparatus defined in claim 24 wherein the finishing machine includes a pair of rotary dies for cutting individual labels from the web stock.

26. A method of digitally controlling the production of custom labeled cartons comprising the steps of:
receiving digital data representing customer information including label graphics and printing to be printed on a package label;
converting the received customer information into a digital format for use by a digital printing press;
digitally printing labels in a shape conforming to cartons onto which the labels are to be applied;
cutting and singulating individual labels;
applying an adhesive to a side of each label opposite the printed side; and
laminating the label and carton by pressing the label and corresponding individual carton in indexed relationship to each other.

27. The method defined in claim 26 and further including varnishing the printed surface of said label prior to the pressing step.

28. The method defined in claim 27 and including the additional step of smoothing the label and carton for removing air bubbles between the label and carton subsequent to the laminating step.

29. A high speed digitally controlled apparatus for forming, printing, and laminating custom labels having a predetermined size and shape corresponding to cartons comprising:
a computer having a microprocessor and a graphics program for laying out label sizes, shapes, and graphic information to be contained on the label and providing an output digital file corresponding to such information;
a digital printer for receiving said output file from said computer and printing a plurality of labels identified by said output file on print stock;
a finishing machine for receiving the print stock, coating the printed side of the label, and cutting and singulating individual labels;
an adhesive application station for applying an adhesive to the carton facing side of each label;
a laminating station for aligning each label in indexed relationship to a carton and pressing the label and carton together to apply the label to the carton;
a smoothing station comprising a rotary press for removing air bubbles between a label and a carton; and
a stacking station for stacking labeled cartons.

30. The apparatus defined in claim 29 wherein the finishing machine includes a pair of rotary dies for cutting individual labels from the print stock.
